(19) United States
(12) Patent Application Publication
(10) Pub. No.: US 2026/0008063 A1
(43) Pub. Date: Jan. 8, 2026

(54) SAFETY DEVICE FOR A BREAKER HAMMER

(71) Applicants: Navinu Newmith Koswatta Liyanage, Tomball, TX (US); Dihen Sensada Koswatta Liyanage, Tomball, TX (US)

(72) Inventors: Navinu Newmith Koswatta Liyanage, Tomball, TX (US); Dihen Sensada Koswatta Liyanage, Tomball, TX (US)

(21) Appl. No.: 18/932,861

(22) Filed: Oct. 31, 2024

Related U.S. Application Data
(60) Provisional application No. 63/666,841, filed on Jul. 2, 2024.

(51) Int. Cl. B02C 23/04; B32B 3/08; B32B 5/02; B32B 15/02; B32B 15/06; B32B 15/18; B32B 25/10; B32B 25/16; B32B 37/18

(52) U.S. Cl. CPC B02C 23/04; B32B 3/08; B32B 5/022; B32B 5/024; B32B 15/02; B32B 15/06; B32B 15/18; B32B 25/10; B32B 25/16; B32B 37/18; B32B 2262/0269; B32B 2305/188; B32B 2307/416; B32B 2307/7265; B32B 2307/7375; B32B 2571/02

(57) ABSTRACT

A safety device for a breaker hammer is provided to enhance safety by preventing stray debris from flying out during operation and causing injury or damage within the operating environment. The cover device comprises multiple layers: EPDM heavy-duty rubber as a base, 304 stainless steel woven wire net for filtration and heat resistance, heavy-duty filter fabric for additional particle capture, and Kevlar fabric for impact resistance. These layers are bonded together and secured around the hammer with ratchet tie-down straps. This protective cover ensures debris containment, reduces the risk of injury and property damage, and allows construction work to proceed safely in high-traffic areas. The device's design balances durability, flexibility, and ease of installation, making it suitable for various construction settings.

### BACKGROUND

### 1. FIELD OF THE INVENTION

The present invention relates generally to safety equipment for heavy-duty machinery, and more specifically, to a safety device for a breaker hammer that contains debris and enhances the safety of the operating environment.

### 2. DESCRIPTION OF RELATED ART

This background information is intended to further educate the reader as to additional aspects of the prior art and may present examples of specific aspects of the prior art that is not to be construed as limiting the disclosure of the present application.

The use of heavy-duty machinery is essential in the construction industry. For example, hydraulic breaker hammers are widely used in construction and demolition for breaking apart rocks, concrete, and other hard materials. However, their use presents significant safety challenges. When a hydraulic breaker hammer is in operation, it generates considerable force, causing fragments of the material being worked on to be ejected at high speeds. These high-velocity projectiles pose a serious hazard to operators as well as nearby workers, vehicles, pedestrians and/or other property within the operating environment.

Current solutions to mitigate these hazards are limited and often inadequate. One common method is the use of excavator window guards, which are designed to protect the operator from flying debris. While effective in protecting the operator, these window guards do not address the safety of other workers on the site or the surrounding environment. Consequently, debris can still cause injuries or damage outside the immediate vicinity of the operator's cab.

Other approaches include setting up exclusion zones around the work area, which restricts access to potentially dangerous zones while the hammer is in operation. While this method reduces the risk to nearby personnel and property, it is highly inefficient. Construction projects often require the constant movement of workers and machinery, and setting up and maintaining these exclusion zones can significantly slow down progress.

Moreover, existing protective measures fail to contain the debris effectively. For instance, temporary barriers or screens set up around the work area may not be robust enough to withstand the impact of high-speed debris. These barriers can also be cumbersome to install and may obstruct the operator's view, further complicating the operation and potentially introducing new safety risks.

Additionally, the cost and practicality of deploying these safety measures on a busy construction site are significant concerns. Heavy-duty barriers and guards can be expensive and difficult to maneuver, and their deployment can lead to extended downtime, impacting project timelines and increasing labor costs.

Furthermore, in urban settings where construction sites are often adjacent to public areas, the risk of debris causing harm to pedestrians and passing vehicles is heightened. Instances of debris striking nearby cars, pedestrians, or structures can result in severe injuries, legal liabilities, and financial losses due to property damage.

Given these challenges, there is a clear and pressing need for an improved solution that not only protects the operator but also ensures the safety of the entire work environment. An effective safety device must contain all debris generated by the hydraulic breaker hammer, be easy to install and remove, and not interfere with the operator's visibility or the efficiency of the operation.

Accordingly, there is a significant need for a safety device for a breaker hammer that can provide comprehensive protection to all personnel and property within the operating environment.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

The safety device for a breaker hammer of the present disclosure addresses the aforementioned deficiencies by providing a comprehensive protective solution to containing debris within an operating environment. By wrapping around the hammer and containing debris, the device significantly reduces the risk of injury and damage, enabling safer and more efficient operations. This invention represents a substantial improvement over existing safety measures, offering enhanced and cost effective protection for workers and the surrounding environment without compromising operational efficiency.

The device is constructed using a combination of high-strength materials, including ethylene propylene diene monomer (EPDM) commercial-grade rubber, 304 stainless steel woven wire net, coated bulletproof ballistic fabric such as Kevlar fabric, and heavy-duty woven or non-woven filter fabric. These materials are selected for their durability and ability to withstand the harsh conditions associated with heavy-duty machinery operation. The EPDM rubber sheet serves as a robust and flexible base, providing a strong foundation for the device. The 304 stainless steel woven wire net functions as a filter to prevent the escape of dust and small particles while also providing structural reinforcement and heat resistance. The bulletproof ballistic fabric is impact—proof and does not allow rocks or dust to pass through, absorbing any dust that might pass through the wire net as well as providing additional structural reinforcement and heat resistance. The heavy-duty filter fabric allows for airflow while containing smaller particles.

One of the primary advantages of this invention is its ability to protect not just the operator, but everyone in the vicinity of the hydraulic breaker hammer. Unlike excavator window guards, which only shield the operator, this device acts as a cover and wraps around the hammer from the middle section to the chisel, effectively containing all debris and preventing it from being ejected into the surrounding area. This significantly reduces the risk of injury to nearby workers and pedestrians, as well as damage to vehicles and property.

Furthermore, the device enhances operational efficiency by allowing work to continue safely even in the presence of nearby traffic and pedestrians. Traditional methods require halting operations to ensure safety when people or vehicles are in the area, leading to frequent interruptions and delays. With the cover device in place, these interruptions are minimized, allowing construction projects to proceed without frequent stoppages, thereby increasing productivity and reducing overall project timelines.

The cover device's design ensures ease of installation and removal, making it practical for use in various construction settings. In one exemplary embodiment, the device measures 5 feet by 2 feet 6 inches (L×W). The layers are assembled as follows: the EPDM heavy-duty rubber is placed as the base layer, followed by the 304 stainless steel woven wire net, then either the heavy-duty woven filter fabric or heavy-duty non-woven filter fabric (depending on the job site requirements), and finally the Kevlar fabric as the top layer. These layers are bonded together using heavy-duty glue.

To secure the cover device onto the breaker hammer, fasteners such as ratchet tie-down straps with S-hooks may be used. Either one or two straps can be used to hold the hydraulic hammer breaker cover in place. Additionally, eyelet pliers may create holes for further fastening with ropes or the like. The sides of the cover device may feature yellow waterproof canvas fabric, adding durability and visibility.

Thus, the safety device for a breaker hammer offers a significant improvement over existing safety measures by providing a robust, comprehensive solution to contain debris and protect the surrounding area. Its use of high-strength materials and thoughtful design ensures both safety and operational efficiency, making it an essential tool for construction and demolition projects. This invention not only reduces the risk of injury and damage but also enhances productivity by minimizing work interruptions, ultimately leading to safer and more efficient project completion.

### BRIEF DESCRIPTION OF THE DRAWINGS

The accompanying drawings, which are incorporated in and constitute a part of this disclosure, illustrate exemplary aspects and, together with the description, serve to explain the disclosed principles. Some aspects of system and/or methods in accordance with aspects of the present subject matter are now described, by way of example only, and with reference to the accompanying Figures, in which:

FIG. 1 is an exploded view showing various layers of a safety device for a breaker hammer, in accordance with a preferred embodiment of the present application;

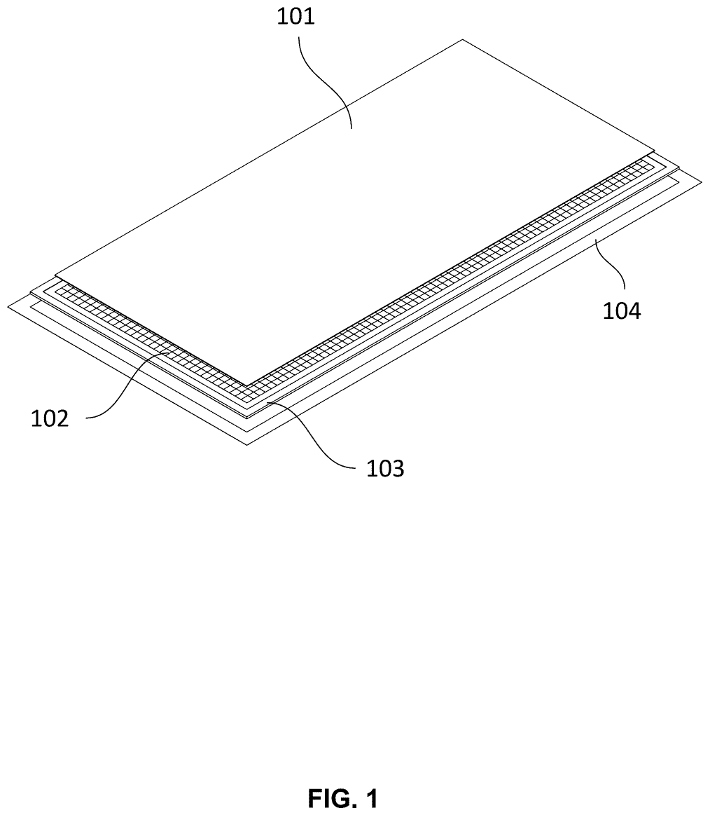

FIG. 2 is a perspective view of the safety device for a breaker hammer in use on a breaker hammer; and

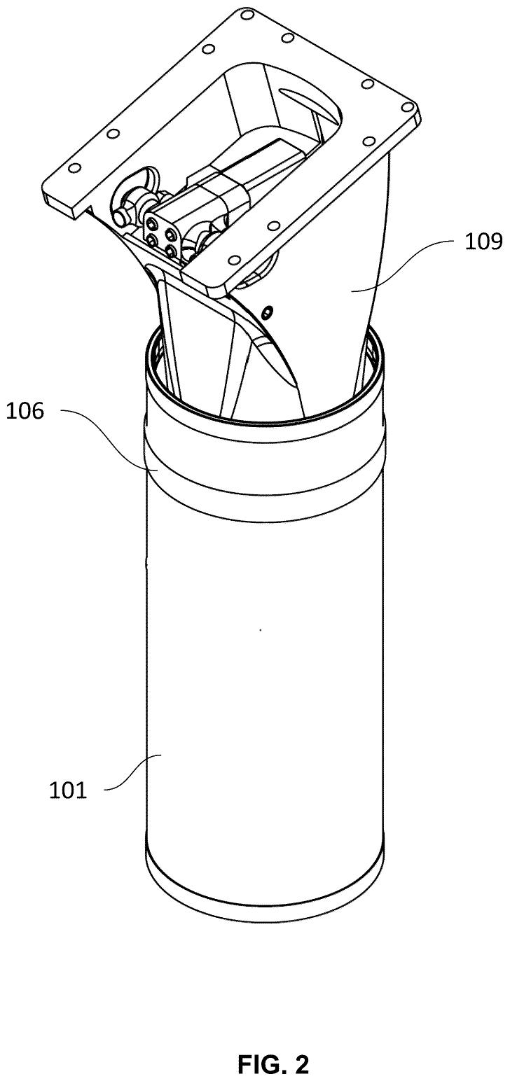

FIG. 3 is a cross sectional view of the safety device for a breaker hammer in use on a breaker hammer.

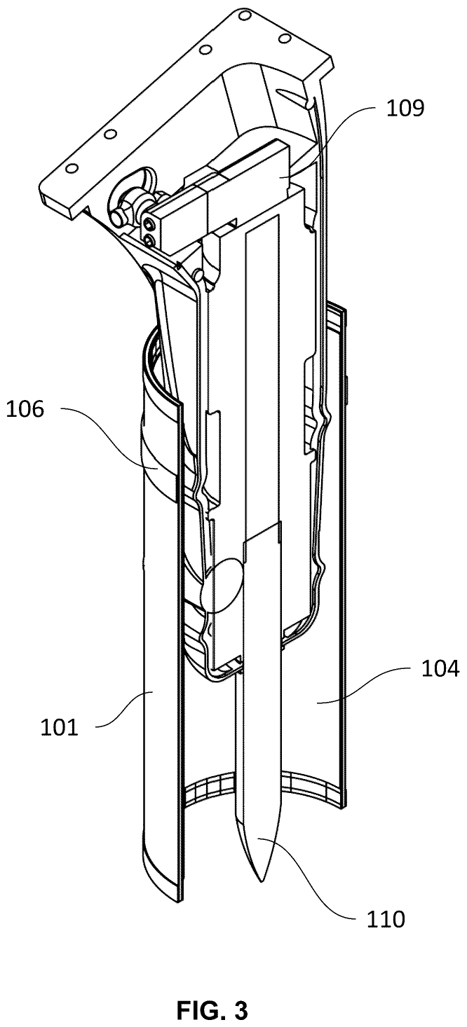

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the invention, reference will now be made to the embodiment illustrated in the drawings, and specific language will be used to describe the same. It will nevertheless be understood that no limitation of the scope of the invention is thereby intended. Such alterations and further modifications in the illustrated system, and such further applications of the principles of the invention as illustrated therein would be contemplated as would normally occur to one skilled in the art to which the invention relates. Unless otherwise defined, all technical and scientific terms used herein have the same meaning as commonly understood by one of ordinary skilled in the art. The system, methods, and examples provided herein are illustrative only and are not intended to be limiting.

The detailed description of the invention is provided to ensure that any person skilled in the art can make and use the invention and is provided in the context of its preferred embodiments, which are illustrative and not restrictive.

The invention of the present disclosure pertains to a safety device for a breaker hammer designed to enhance safety by containing debris generated during operation of a hydraulic breaker hammer. The cover device addresses the significant safety challenges posed by high-velocity projectiles that can cause serious injury and damage.

The cover device comprises multiple layers of high-strength materials, each selected for its specific properties to provide maximum protection and durability. The primary layer is a EPDM commercial-grade rubber sheet 101. This rubber sheet 101 serves as a robust and flexible base, providing a strong foundation that can withstand the harsh conditions of construction and demolition sites. In an exemplary embodiment, the EPDM layer 101 may measure about 5 feet 3 inches by 2 feet 9 inches.

Disposed on the rubber sheet 101 is a layer of 304 stainless steel woven wire net 102. This wire net layer 102 functions as a filter to prevent the escape of dust and small particles while also providing heat resistance.

The next layer is a heavy-duty filter fabric 103. This filter fabric layer 103 allows airflow while containing smaller particles, preventing the buildup of dust and other fine debris. The filter fabric 103 ensures that the cover does not interfere with the operation of the hydraulic hammer by allowing necessary ventilation. The heavy-duty filter fabric 103 may be either woven or non-woven, depending on the specific job site requirements.

The outermost layer is the coated bulletproof ballistic fabric 104. This material is essential for containing high-velocity debris, ensuring that even the most forceful projectiles are not ejected from the cover. The ballistic fabric 104 is coated to enhance its durability and resistance to environmental factors such as moisture and UV radiation. The ballistic fabric 104 is impact-proof and does not allow rocks or dust to pass through, absorbing any dust that might pass through the wire net 102. The ballistic fabric 104 also provides additional heat resistance.

The assembly of the cover device involves layering the EPDM rubber sheet 101, 304 stainless steel woven wire net 102, heavy-duty filter fabric 103, and ballistic fabric 104. These layers are bonded together using a heavy-duty adhesive such as glue. The adhesive is chosen for its strong bonding properties and its ability to withstand the stresses and vibrations associated with the operation of hydraulic breaker hammers. About three inches of the rubber sheet 101 may be wrapped inward over the top of the ballistic fabric 104 to provide additional security and prevent any edges from being exposed.

To secure the cover device onto a breaker hammer 109, one or more fasteners 106 such as ratchet tie-downs or ropes are used. The fasteners 106 provide a reliable and adjustable means of securing the cover device, ensuring it stays in place during operation. In one embodiment, the plurality of fasteners 106 may be ropes that may be threaded through eyelets.

Around the sides and/or outer edges of the cover device may feature yellow waterproof canvas fabric. This fabric not only adds durability to the sides of the cover but also increases visibility, enhancing safety by making the covered hammer more noticeable on the construction site.

While in use, the cover device wraps around the breaker hammer 109 from a middle section to a hammer chisel 110. The cover device while wrapped around the breaker hammer chisel 110 effectively contains debris that is produced while the breaker hammer 109 is in operation and prevents it from being forcefully ejected into the surrounding areas of the operating environment.

One of the primary advantages of this invention is the ability to protect everyone in the vicinity of the hydraulic breaker hammer 109, not just the operator. Traditional methods, such as excavator window guards, only shield the operator, leaving others exposed to the hazards of flying debris. By containing all debris within the cover, the present invention provides a safer working environment for all personnel on the site and in surrounding areas that stray debris may reach.

Another significant advantage is the enhancement of operational efficiency. Traditional safety measures often require work to be halted when pedestrians or vehicles are nearby, leading to frequent interruptions and delays. With the breaker hammer cover device in place, these interruptions are minimized, allowing construction projects to proceed without frequent stoppages, thereby increasing productivity and reducing overall project timelines.

The hydraulic hammer breaker cover can be customized and modified to suit specific needs and preferences. Optional features may include additional layers of protective material for enhanced durability, custom sizes, reinforced edges for added security, and custom fasteners 106 to fit different types of breaker hammers 109.

In some embodiments, the breaker hammer cover device may further comprise integrating reflective strips or LED lights for increased visibility in low-light conditions, adding handles or straps for easier installation and removal, and incorporating ventilation flaps to improve airflow and prevent overheating of the hydraulic breaker hammer 109.

In some embodiments, the breaker hammer cover device may further comprise modular components, allowing sections to be replaced individually if damaged, rather than replacing the entire cover. This modular approach could extend the lifespan of the cover and reduce maintenance costs.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the embodiments is by no means limited by these specific examples. Numerous variations, whether explicitly given in the specification or not, such as differences in structure, dimension, and use of material, are possible.

What is claimed is:

1. A safety device for a breaker hammer, comprising:
a base layer;
a filter layer bonded to the base layer;
a ballistic layer bonded to the filter layer;
wherein the base layer, the filter layer and the ballistic layer form a unitary covering configured to attach to a breaker hammer body housing unit and enclose the breaker hammer chisel; and
at least one fastener attached to the covering and configured to secure the covering to the breaker hammer.

2. The safety device for a breaker hammer of claim 1, wherein the at least one fastener is ratchet tie-downs.

3. The safety device for a breaker hammer of claim 1, wherein the at least one fastener is rope.

4. The safety device for a breaker hammer of claim 1, further comprising a waterproof fabric layer disposed around an outer edge of the covering.

5. The safety device for a breaker hammer of claim 1, wherein the waterproof fabric layer is a reflective material for increased visibility.

6. The safety device for a breaker hammer of claim 1, wherein the base layer is composed of ethylene propylene diene monomer (EPDM) heavy-duty rubber.

7. The safety device for a breaker hammer of claim 1, wherein the filter layer is selected from the group consisting of 304 stainless steel woven wire net, heavy-duty woven filter fabric, heavy-duty non-woven filter fabric, and any combination thereof.

8. The safety device for a breaker hammer of claim 1, wherein the ballistic layer is composed of Kevlar felt.

9. The safety device for a breaker hammer of claim 1, wherein the unitary covering measures approximately 5 feet by 2 feet by 6 inches.

10. A method of manufacturing a safety device for a breaker hammer, the method comprising:
placing a base layer;
layering a filter layer on top of the base layer;
adding a ballistic layer on top of the filter layer;
bonding the base layer, the filter layer, and the ballistic layer together to form a unitary covering; and
attaching at least one fastener to the unitary covering for securing the covering to a breaker hammer enclosing the breaker hammer chisel.

11. The method of manufacturing a safety device for a breaker hammer of claim 10, wherein the at least one fastener is ratchet tie-downs.

12. The method of manufacturing a safety device for a breaker hammer of claim 10, wherein the at least one fastener is rope.

13. The method of manufacturing a safety device for a breaker hammer of claim 10, further comprising the step of adding a waterproof fabric layer disposed around an outer edge of the covering.

14. The method of manufacturing a safety device for a breaker hammer of claim 13, wherein the waterproof fabric layer is a reflective material for increased visibility.

15. The method of manufacturing a safety device for a breaker hammer of claim 10, wherein the base layer is composed of ethylene propylene diene monomer (EPDM) heavy-duty rubber.

16. The method of manufacturing a safety device for a breaker hammer of claim 10, wherein the filter layer is selected from the group consisting of 304 stainless steel woven wire net, heavy-duty woven filter fabric, heavy-duty non-woven filter fabric, and any combination thereof.

17. The method of manufacturing a safety device for a breaker hammer of claim 16, wherein the filter layer is selected based on predetermined job site requirements.

18. The method of manufacturing a safety device for a breaker hammer of claim 10, wherein the ballistic layer is composed of Kevlar felt.

19. The method of manufacturing a safety device for a breaker hammer of claim 10, wherein the unitary covering measures approximately 5 feet by 2 feet by 6 inches.

20. A method for enhancing safety in breaker hammer operations, comprising:
providing the safety device of claim 1;
providing a breaker hammer; and
wrapping the safety device around a breaker hammer body housing unit from a middle section to a hammer chisel, wherein debris produced during operation of the breaker hammer is completely contained within the safety device.
